(19) United States
(12) Patent Application Publication
(10) Pub. No.: US 2020/0150691 A1
(43) Pub. Date: May 14, 2020

(54) CONTROL METHOD, PROCESSING DEVICE, PROCESSOR, AIRCRAFT, AND SOMATOSENSORY SYSTEM

(71) Applicant: SZ DJI TECHNOLOGY CO., LTD., Shenzhen (CN)

(72) Inventors: Zhipeng ZHANG, Shenzhen (CN); Xiaojun YIN, Shenzhen (CN); Naibo WANG, Shenzhen (CN); Ning MA, Shenzhen (CN)

(21) Appl. No.: 16/591,165

(22) Filed: Oct. 2, 2019

Related U.S. Application Data
(63) Continuation of application No. PCT/CN2017/079756, filed on Apr. 7, 2017.

(51) Int. Cl. G05D 1/10; B64D 47/08; G01C 11/04; G05D 1/00

(52) U.S. Cl. CPC G05D 1/101; G05D 1/0094; G01C 11/04; B64D 47/08

(57) ABSTRACT

A processing method for an aircraft includes controlling an imaging device of the aircraft to capture an image. The processing method also includes associating and saving the image and flight control information of a flight control module of the aircraft relating to a time when the imaging device captures the image.

### CROSS-REFERENCE TO RELATED APPLICATIONS

This application is a continuation application of International Application No. PCT/CN2017/079756, filed on Apr. 7, 2017, the entire content of which is incorporated herein by reference.

### TECHNICAL FIELD

The present disclosure relates to the technology field of consumer electronics and, more particularly, to a control method, a processing device, a processor, an aircraft, and a somatosensory system.

### BACKGROUND

In related technologies, videos obtained from aerial photography typically do not include somatosensory information. To realize user experience on every sensing organ, the somatosensory information is typically generated through late stage simulation. The process of generating the somatosensory information is relatively complex, costly, and usually consumes a lot of time.

### SUMMARY

According to an aspect of the present disclosure, there is provided a processing method for an aircraft that includes controlling an imaging device of the aircraft to capture an image. The processing method also includes associating and saving the image and flight control information of a flight control module of the aircraft relating to a time when the imaging device captures the image.

According to another aspect of the present disclosure, there is provided an aircraft including an imaging device. The aircraft also includes a flight control module configured to control the imaging device to capture an image. The flight control module is also configured to associate and save the image and flight control information of the flight control module relating to a time when the imaging device captures the image.

According to another aspect of the present disclosure, there is provided a somatosensory system. The somatosensory system includes an aircraft comprising an imaging device and a flight control module. The somatosensory system also includes a somatosensory device. The somatosensory system further includes a processor configured to control the imaging device to capture an image. The processor is also configured to associate and save the image and flight control information of the flight control module relating to a time when the imaging device captures the image.

According to the control method, processing device, processor, aircraft, and somatosensory system of the present disclosure, images and flight control information may be associated and stored, such that the flight control information and the images are synchronized in time, which can save time and cost for late stage editing for a user.

Some of the additional aspects and advantages of the present disclosure will be described in the following descriptions, some will become obvious in the following descriptions, or some may be learned from practicing the technical solutions of the present disclosure.

### BRIEF DESCRIPTION OF THE DRAWINGS

To better describe the technical solutions of the various embodiments of the present disclosure or the existing technology, the accompanying drawings needed to describe the embodiments or the existing technology will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a flow chart illustrating a processing method, according to an example embodiment.

FIG. 2 is a schematic diagram of modules of a somatosensory system, according to an example embodiment.

FIG. 3 is a schematic diagram of modules of a somatosensory system, according to another example embodiment.

FIG. 4 is a flow chart illustrating a processing method, according to another example embodiment.

FIG. 5 is a schematic diagram of modules of an aircraft, according to an example embodiment.

FIG. 6 is a flow chart illustrating a processing method, according to another example embodiment.

FIG. 7 is a schematic diagram of modules of an aircraft, according to another example embodiment.

FIG. 8 is a schematic diagram of modules of an aircraft, according to another example embodiment.

FIG. 9 is a flow chart illustrating a processing method, according to another example embodiment.

FIG. 10 is a schematic diagram of modules of a processing device, according to an example embodiment.

FIG. 11 is a schematic diagram of modules of a somatosensory device, according to an example embodiment.

### DESCRIPTIONS OF LABELS OF MAIN COMPONENTS IN THE ACCOMPANYING DRAWINGS

1000—somatosensory system; 100—aircraft; 10—imaging device; 20—flight control module; 30—timing device; 40—angular sensor; 50—rotor motor; 60—gimbal; 700—somatosensory device; 720—head somatosensory device; 740—body somatosensory device; 800—processing device; 820—first processing module; 840—second processing module; 900—processor.

### DETAILED DESCRIPTION OF THE EMBODIMENTS

To make the objective of the present disclosure, the technical solution, and the advantages clearer, technical solutions of the embodiments of the present disclosure will be described in a clear and complete manner with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “vertical,” “left,” “right,” “up,” “upward,” “upwardly,” “down,” “downward,” “downwardly,” and similar expressions used herein are merely intended for describing relative positional relationships.

A person having ordinary skill in the art can appreciate that when the term “and/or” is used, the term describes a relationship between related items. The term “A and/or B” means three relationships may exist between the related items. For example, A and/or B can mean A only, A and B, and B only. The symbol “/” means “or” between the related items separated by the symbol. The phrase “at least one of A, B, or C” encompasses all combinations of A, B, and C, such as A only, B only, C only, A and B, B and C, A and C, and A, B, and C. The term “and/or” may be interpreted as “at least one of.”

The terms “comprise,” “comprising,” “include,” and the like specify the presence of stated features, steps, operations, elements, and/or components but do not preclude the presence or addition of one or more other features, steps, operations, elements, components, and/or groups. The term “communicatively couple(d)” or “communicatively connect(ed)” indicates that related items are coupled or connected through a communication channel, such as a wired or wireless communication channel. The term “unit,” “sub-unit,” or “module” may encompass a hardware component, a software component, or a combination thereof. For example, a “unit,” “sub-unit,” or “module” may include a housing, a device, a sensor, a processor, an algorithm, a circuit, an electrical or mechanical connector, etc.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

It should be understood that in the present disclosure, relational terms such as “first” and “second,” etc., are only used to distinguish an entity or operation from another entity or operation, and do not necessarily require or imply that there is an actual relationship or order between the entities or operations. Therefore, a “first” or “second” feature may include, explicitly or implicitly, one or more such features. The term “multiple” means two or more than two, unless otherwise defined.

The following descriptions provide various different embodiments or examples to illustrate the realization of different structures of the present disclosure. For simplicity of the present disclosure, parts and settings of specific examples are described below. Of course, they are illustrations only, and are not intended to limit the scope of the present disclosure. In addition, the same numbers and/or reference alphabets may be repeatedly used in different examples of the present disclosure. Such repetition is for the purpose of simplicity and clarity, and does not indicate any relationship between the various embodiments and/or settings. Further, the present disclosure provides examples of various specific processes and materials. A person having ordinary skills in the art can appreciate that other processes and/or other materials can be used.

Embodiments of the present disclosure shown in the drawings will be described in detail below. Example embodiments are shown in the drawings. The same or similar reference numerals refer to the same or similar components or components having the same or similar functions. The descriptions of the embodiments with reference to the drawings are illustrative, and are only used to explain the present disclosure, and cannot be understood as being limiting the scope of the present disclosure.

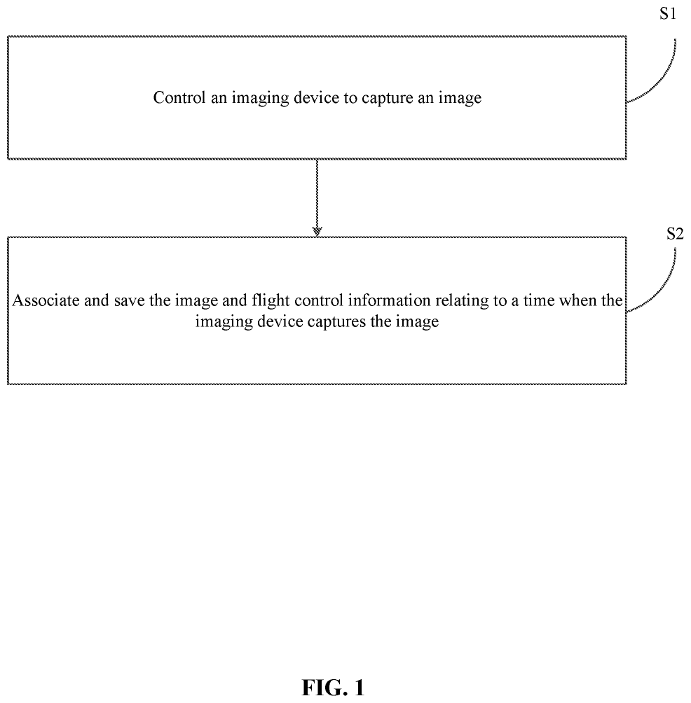

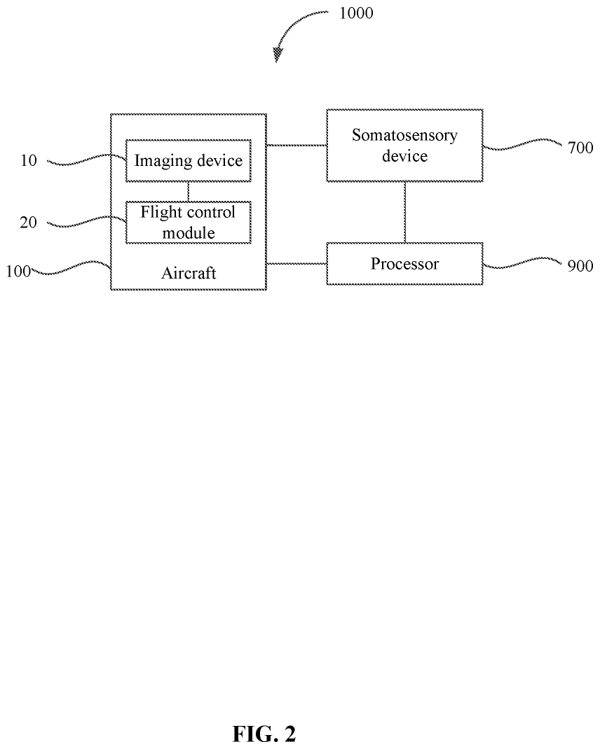

Referring to FIG. 1 and FIG. 2, the processing method of the present disclosure may be used in a somatosensory system 1000. The somatosensory system 1000 may include an aircraft 100 and a somatosensory device 700. The aircraft 100 may include an imaging device 10 and a flight control module (or flight controller) 20. The processing method may include the following steps:

S1: controlling the imaging device 10 to capture an image;

S2: associating and saving the image and flight control information of the flight control module 20 relating to a time when the imaging device 10 captures the image.

Referring to FIG. 2, the somatosensory system 1000 of the present disclosure may include the aircraft 100, the somatosensory device 700, and a processor 900. The aircraft 100 may include the imaging device 10 and the flight control module 20. The processor 900 may be configured to control the imaging device 10 to capture the image and to associate and save the image and flight control information of the flight control module 20 relating to a time when the imaging device 10 captures the image. The image may include static and dynamic images, i.e., a photo and/or a video. When the image is a photo, the image may be associated with the flight control information of the flight control module 20 relating to a time when the image is captured. When the image is a video, the video may be associated with the flight control information of the flight control module 20 relating to a time when the video is captured.

In other words, the processing method of the present disclosure may be realized by the somatosensory system 1000. Steps S1 and S2 may be realized by the processor 900.

In some embodiments, the processor 900 may be implemented in the aircraft 100. In other words, the flight control module 20 may include the processor 900. That is, the steps S1 and S2 may be realized by the flight control module 20.

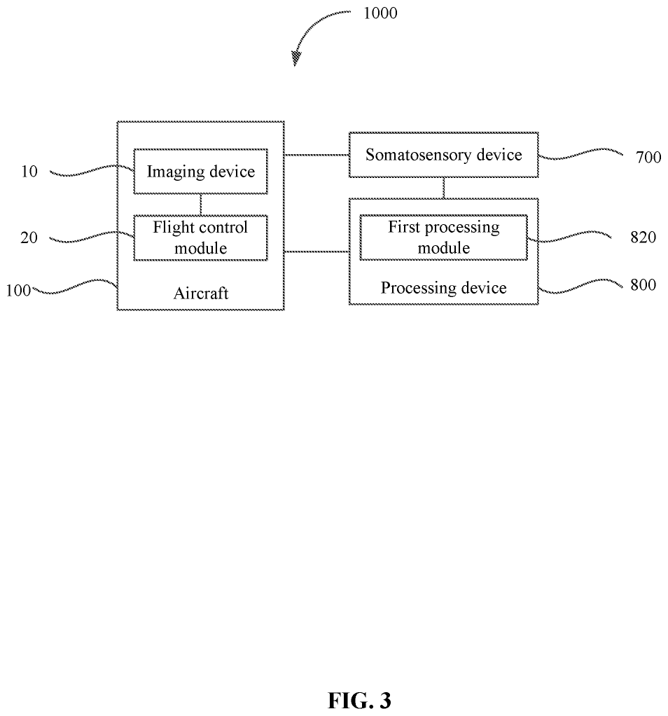

Referring to FIG. 3, in some embodiments, the processing device 800 of the present disclosure may include a first processing module 820 (or a first processor 820). The first processing module 820 may be configured to associate the image with the flight control information. The processing device 800 and the processor 900 of the present disclosure may be implemented in the aircraft 100, the somatosensory device 700 or other electronic devices. The other electronic devices may be cell phones, tablets, personal computers.

The control method, processing device 800, processor 900, aircraft 100, and somatosensory system 1000 may associate and save the image and the flight control information, such that the flight control information and the image are synchronized in time, which saves the time and cost for late stage editing for the user.

In some embodiments, the aircraft 100 may include an unmanned aerial vehicle.

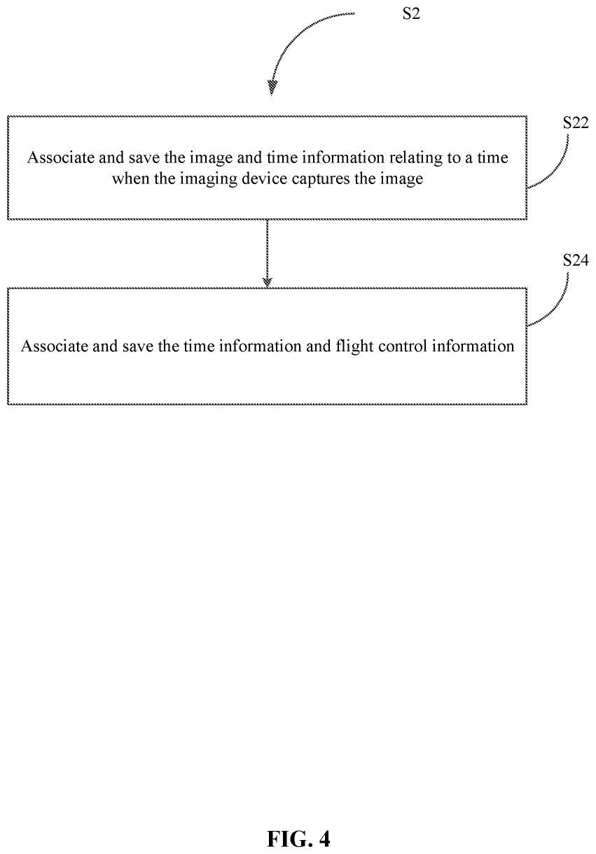

Referring to FIG. 4, in an embodiment, step S2 may include the following steps:

S22: associating and saving the image and the time information relating to a time when the imaging device 10 captures the image; and

S24: associating and saving the time information and the flight control information.

In an embodiment, the processor 900 may be configured to associate and save the image and the time information relating to a time when the imaging device 10 captures the image, and to associate and save the time information and the flight control information.

In other words, steps S22 and S24 may be implemented by the processor 900.

As such, the image and the flight control information may be associated.

Referring back to FIG. 3, in an embodiment, the first processing module 820 may be configured to associate the image with the flight control information based on the time information.

Specifically, the image and the flight control information each has independent time information. Thus, the image and the flight control information may be associated based on the time information, such that the image and the flight control information are synchronized in time. In other words, the image and the flight control information correspond to the same time information may be found and the image and the flight control information correspond to the same time information may be associated.

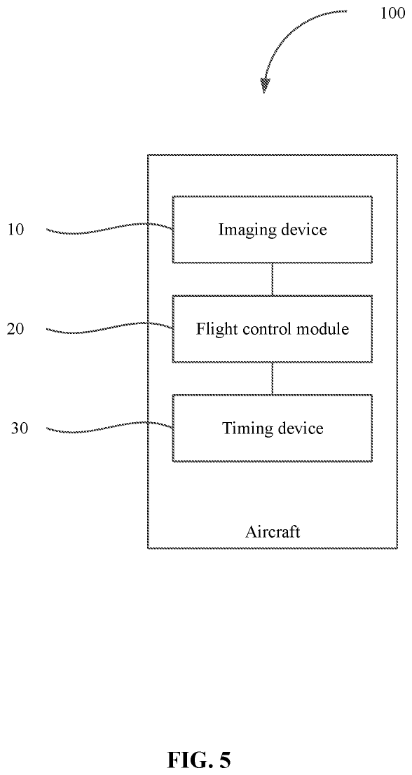

Referring to FIG. 5, in an embodiment, the aircraft 100 may include a timing device 30 configured to provide time information.

As such, the time information may be obtained from the timing device 30.

It is understood that the imaging device 10 of the aircraft 100 may obtain the time information provided by the timing device 30 of the aircraft 100 when the imaging device 10 captures the image, thereby ensuring the real time nature and the accuracy of the time information of the image. In addition, the time information provided by the timing device 30 may be used to associate with the flight control information, such that the flight control information includes time information.

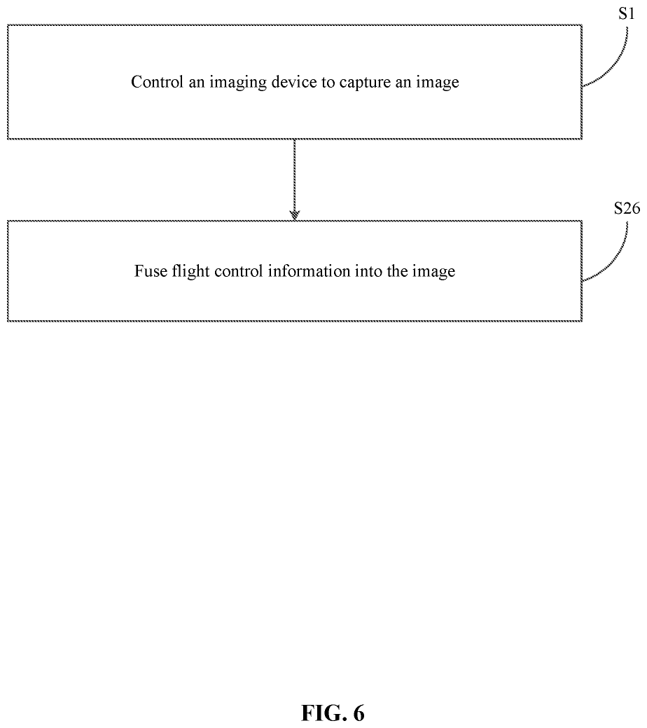

Referring to FIG. 6, in an embodiment, step S2 may also include the following steps:

S26: fusing the flight control information into the image.

Referring back to FIG. 2, in an embodiment, the processor 900 may be configured to fuse the flight control information into the image.

In other words, step S26 may be implemented by the processor 900.

As such, the flight control information and the image may realize synchronization in time.

Referring back to FIG. 3, in an embodiment, the first processing module 820 may be configured to fuse the flight control information into the image.

It can be understood, there may be some errors in the process of associating the image and the flight control information based on the time information, which may cause the image and the flight control information to be not synchronized. Fusing the flight control information into the image may ensure the image and the flight control information are highly synchronized in time, thereby reducing or avoiding error.

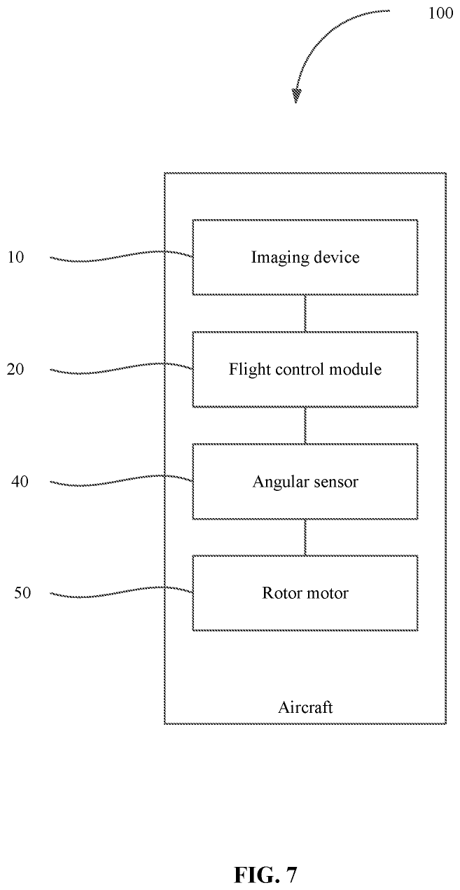

Referring to FIG. 7, in an embodiment, the aircraft 100 may include an angular sensor 40 and/or a rotor motor 50 (or at least one of an angular sensor 40 or a rotor motor 50). The flight control information may include the operation status information of the angular sensor 40 and/or the rotor motor 50.

As such, the operation status information of the angular sensor 40 and/or the rotor motor 50 may be obtained.

Specifically, the aircraft 100 including the angular sensor 40 and/or the rotor motor 50 means any of the following: the aircraft 100 includes the angular sensor 40, the aircraft 100 includes the rotor motor 50, the aircraft 100 includes the angular sensor 40 and the rotor motor 50. Correspondingly, the flight control information may include the operation status information of the angular sensor 40. In some embodiments, the flight control information may include the operation status information of the rotor motor 50. In some embodiments, the flight control information may include the operation status information of the angular sensor 40 and/or the rotor motor 50. The operation status of the aircraft 100 may be determined based on the operation status information of the angular sensor 40 and/or the rotor motor 50. Therefore, the somatosensory device 700 may be controlled based on the operation status of the aircraft 100.

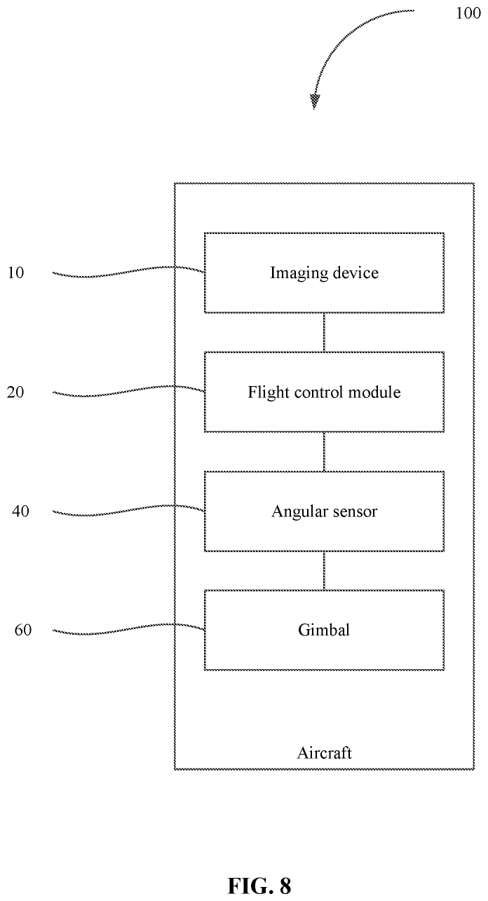

Referring to FIG. 8, in an embodiment, the aircraft 100 may include a gimbal 60. The angular sensor 40 may be configured to detect the attitude information of the gimbal 60. The operation status information of the angular sensor 40 may include the pitch angle, yaw angle, and roll angle of the gimbal 60.

As such, the operation status of the gimbal 60 may be obtained based on the operation status information of the angular sensor 40.

In an embodiment, the gimbal 60 may be a three-axis gimbal. The operation status of the gimbal 60 may include a pitch status, a yaw status, and a roll status. Based on the operation status information of the angular sensor 40, the operation status of the corresponding gimbal 60 may be obtained. For example, when the pitch angle of the gimbal 60 obtained by the angular sensor 40 is 5 degrees, it indicates that the operation status of the gimbal is that the gimbal has been raised upward by 5 degrees. Therefore, based on the operation status information of the angular sensor 40, the pitch angle, yaw angle, and roll angle of the gimbal 60 may be quickly obtained. Further, the operation status of the gimbal 60 may be determined. It can be understood that in other embodiments, the gimbal 60 may be other types of gimbal, which is not limited.

Referring back to FIG. 2, in an embodiment, the processor 900 may be configured to process the flight control information to obtain somatosensory control information and to control the somatosensory device 700 based on the somatosensory control information.

As such, the somatosensory device 700 may obtain the somatosensory control information and may control the somatosensory device 700 based on the somatosensory control information.

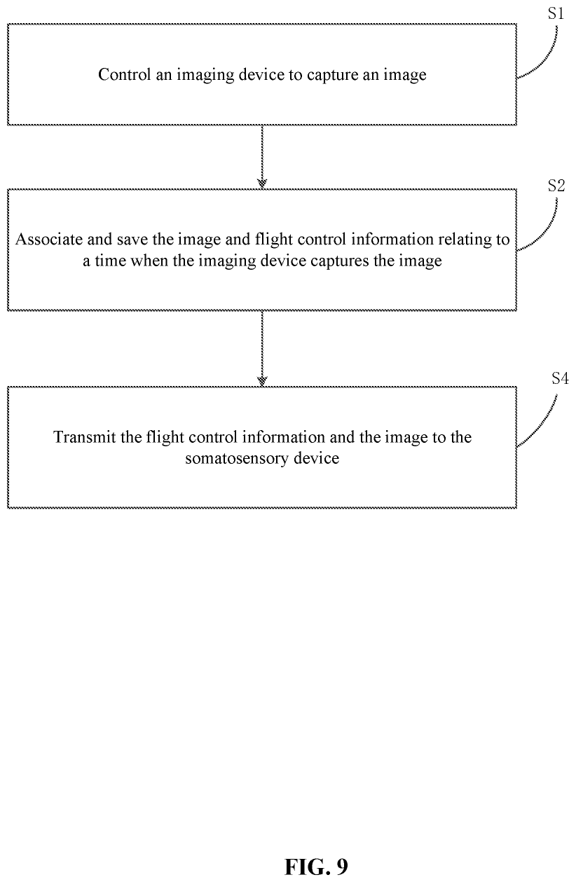

Referring to FIG. 9, in an embodiment, the processor 900 may be implemented in the aircraft 100. That is, the flight control module 20 may include the processor 900. The aircraft 100 may communicate with the somatosensory device 700. The processing method may include the following steps:

S4: transmitting the flight control information and the image to the somatosensory device 700, such that the somatosensory device 700 processes the flight control information to obtain the somatosensory control information and to control the somatosensory device 700 based on the somatosensory control information.

Referring back to FIG. 2, in an embodiment, the processor 900 may be implemented in the aircraft 100. That is, the flight control module 20 may include the processor 900. The aircraft 100 and the somatosensory device 700 may communicate with one another. The flight control module 20 may be configured to transmit the flight control information and the image to the somatosensory device 700, such that the somatosensory device 700 is configured to process the flight control information to obtain the somatosensory control information and to control the somatosensory device 700 based on the somatosensory control information.

In other words, the step S4 may be implemented by the processor 900. The processor 900 may be implemented in the flight control module 20.

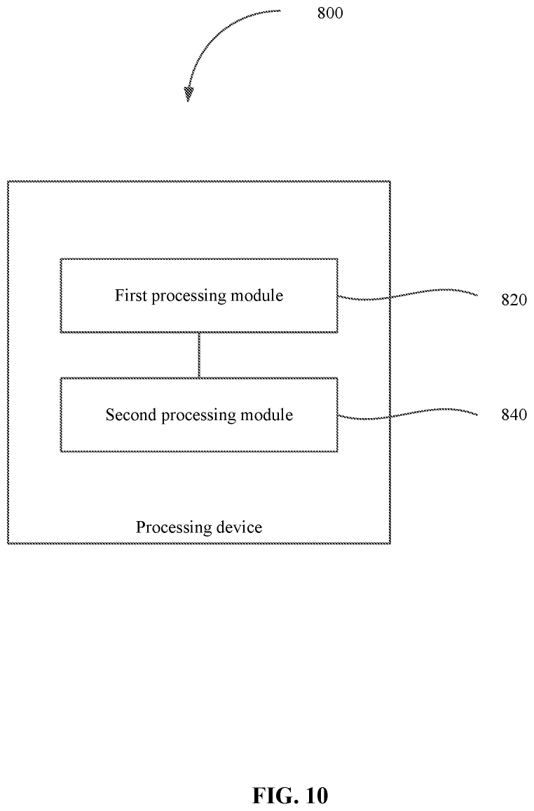

Referring to FIG. 10, in an embodiment, the processing device 800 may include a second processing module 840 (or a second processor 840). The second processing module 840 may be configured to process the flight control information to obtain the somatosensory control information.

Specifically, the somatosensory control information may be obtained by the second processing module 840 or the processor 900. As such, through processing the flight control information, the corresponding somatosensory control information may be quickly obtained. The somatosensory control information may be used to control the somatosensory device 700, thereby producing the corresponding somatosensory feeling.

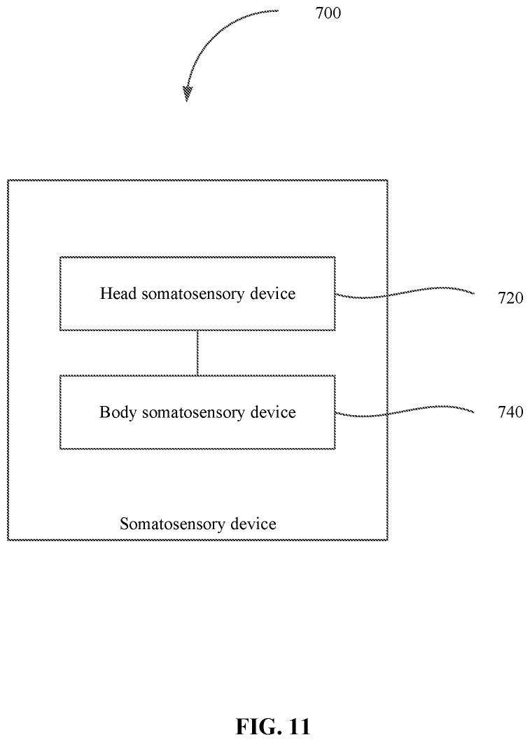

In an embodiment, the operation status information of the rotor motor 50 may be used for determining the attitude information of the aircraft 100. Referring to FIG. 11, the somatosensory device 700 may include a head somatosensory device 720 and a body somatosensory device 740. The somatosensory control information may include head control information for controlling the head somatosensory device 720 and body control information for controlling the body somatosensory device 740. The processor 900 may be configured to determine the head control information and the body control information based on the attitude information of the gimbal 60 and the attitude information of the aircraft 100.

As such, the head somatosensory device 720 and the body somatosensory device 740 may be controlled based on the attitude information of the gimbal 60 and the attitude information of the aircraft 100.

Specifically, when the attitude information of the gimbal 60 is upward, the head somatosensory device 720 may be controlled to generate a somatosensory feel of raising head. When the attitude information of the gimbal 60 is downward, the head somatosensory device 720 may be controlled to generate a somatosensory feel of head down. When the attitude information of the aircraft 100 is hover or ascending or descending at a constant speed, the head somatosensory device 720 and the body somatosensory device 740 may be controlled to generate a somatosensory feel of stillness. When the attitude information of the aircraft is ascending acceleratively, the head somatosensory device 720 may be controlled to generate a somatosensory feel of head down and the body somatosensory device 740 may be controlled to generate a somatosensory feel of overweight. When the attitude information of the aircraft 100 is descending acceleratively, the head somatosensory device 720 may be controlled to generate a somatosensory feel of raising head and the body somatosensory device 740 may be controlled to generate a somatosensory feel of weightlessness. When the attitude information of the aircraft 100 is moving forward at a constant speed, moving backward at a constant speed, or performing a yaw, the head somatosensory device 720 may be controlled to generate a somatosensory feel of a still head, and the body somatosensory device 740 becomes still to generate a somatosensory feel of body tilting. The angle and direction of the tilting may be determined based on the operation status information of the rotor motor. When the attitude information of the aircraft 100 is accelerating forward, accelerating backward, the head somatosensory device 720 may be controlled to generate a somatosensory feel of a still head, and the body somatosensory device 740 becomes still to generate a somatosensory feel of body tilting. The angle and direction of the tilting may be determined based on the operation status information of the rotor motor. When the attitude information of the aircraft 100 is rotating, the head somatosensory device 720 may be controlled to generate a somatosensory feel of rotating head.

It is understood that the situations of controlling the head somatosensory device 720 and the body somatosensory device 740 based on the attitude information of the gimbal 60 and the attitude information of the aircraft 100 may be combined. For example, when the attitude information of the gimbal 60 is upward and the attitude information of the aircraft 100 is ascending acceleratively, the head somatosensory device 720 may be controlled to generate a somatosensory feel of still head and the body somatosensory device 740 may be controlled to generate a somatosensory feel of overweight. The present disclosure does not limit any of these.

In the description of the present disclosure, a person having ordinary skill in the art can appreciate that when the description mentions “an embodiments,” “some embodiment,” “illustrative embodiments,” “an example,” “a specific example,” or “some examples,” it means that characteristics, structures, or features related to the embodiment or example are included in at least one embodiment or example of the present disclosure. In the present descriptions, the illustrative expressions of the above terms do not necessarily mean the same embodiments or examples. Further, various characteristics, structures, materials, or features may be combined in any one or multiple embodiments or examples in a suitable manner.

Any process or method described in the flow chart or in other manner in this description may be understood as one or more modules, segments, or portions of codes of executable instructions for executing specific logic function or steps of processes. In addition, the scope of the preferred embodiments of the present disclosure includes other executions. The order of execution may not adopt the illustrated or described order. Functions may be executed based on substantially the same or opposite orders based on the functions involved, which can be appreciated by a person having ordinary skills in the art of the embodiments of the present disclosure.

The logic and/or steps illustrated in the flow charts or described in other manners, for example, may be regarded as a fixed order list of executable instructions configured to execute the logic functions, and may be specifically executed in any computer-readable medium, which may be used by a command executing system, a device, or apparatus (e.g., a computer based system, a system having a processor, or other systems that can retrieve and execute instructions from an instruction execution system, device, or apparatus), or may be used in combination with the instruction execution system, device, or apparatus. For the present descriptions, the “computer-readable medium” may be any device that may include, store, communicate, broadcast, or transmit programs for use by an instruction execution system, device, or apparatus, or for use in combination with the instruction execution system, device, or apparatus. Detailed examples of the computer-readable medium may include: an electrical connector (e.g., electronic device) having one or more wiring configurations, a portable computer disk (e.g., a magnetic device), a random access memory (“RAM”), a read only memory (“ROM”), an erasable programmable read only memory (“EPROM” or flash memory), an optical device, and a compact disc read only optical memory (“CDROM”). In addition, the computer-readable medium may be paper or any other medium on which the program may be printed, because the paper or the other medium may be optically scanned, edited, analyzed, or, if needed, processed in other suitable manner to obtain the program electronically, and then store the program in the computer storage device.

It should be understood, the various portions of the present disclosure may be executed via hardware, software, firmware, or a combination thereof. In the above embodiments, multiple steps or methods may be executed by software or firmware stored in the storage device, and executed by a suitable instruction execution system. For example, if executed by hardware, similar to the other embodiment, the execution may be performed by any of the following technologies or any combination thereof: a discrete logic circuit having a logic gate circuit for executing logic functions for digital signals, an application specific integrated circuit having a suitable combination of logic gate circuits, a programmable field array (“PGA”), a field programmable gate array (“FPGA”), etc.

A person having ordinary skills in the art can appreciate that the some or all of the steps of the methods disclosed herein may be implemented through program instructing related hardware. The program may be stored in a computer-readable storage medium. When the program is executed, the program may include one of the steps in any embodiment of the method or a combination of the steps.

Various functional units or components may be integrated in a single processing unit, or may exist as separate physical units or components. In some embodiments, two or more units or components may be integrated in a single unit or component. The integrated unit may be realized using hardware or a combination of hardware and software. When the integrated modules are executed in the form of a software functional module and sold or used as an independent product, the integrated modules may be stored in a computer-readable storage medium.

The above-mentioned storage medium may be a read only storage device, a magnetic disk, or an optical disk, etc. Although embodiments have been illustrated and described above, it is understood that these embodiments are illustrative, and cannot be understood as limiting the present disclosure. A person having ordinary skills in the art can change, modify, replace, or vary the above embodiments within the scope of the present disclosure.

What is claimed is:

1. A processing method for an aircraft, comprising:
controlling an imaging device of the aircraft to capture an image; and
associating and saving the image and flight control information of a flight control module of the aircraft relating to a time when the imaging device captures the image.

2. The processing method of claim 1, wherein associating and saving the image and flight control information of the flight control module of the aircraft relating to the time when the imaging device captures the image comprises:
associating and saving the image and time information relating to the time when the imaging device captures the image; and
associating and saving the time information and the flight control information.

3. The processing method of claim 2, further comprising providing the time information by a timing device of the aircraft.

4. The processing method of claim 1, wherein associating and saving the image and flight control information of the flight control module of the aircraft relating to the time when the imaging device captures the image comprises:
fusing the flight control information into the image.

5. The processing method of claim 1, wherein the flight control information comprises operation status information of at least one of an angular sensor of the aircraft or a rotor motor of the aircraft.

6. The processing method of claim 1, wherein the aircraft is configured to communicate with a somatosensory device, and wherein the processing method further comprises:
transmitting the flight control information and the image to the somatosensory device, to enable the somatosensory device to process the flight control information to obtain somatosensory control information and to control the somatosensory device based on the somatosensory control information.

7. An aircraft, comprising:
an imaging device; and
a flight control module configured to:
control the imaging device to capture an image; and
associate and save the image and flight control information of the flight control module relating to a time when the imaging device captures the image.

8. The aircraft of claim 7, wherein the flight control module is configured to:
associate and save the image and time information relating to the time when the imaging device captures the image; and
associated and save the time information and the flight control information.

9. The aircraft of claim 8, further comprising a timing device configured to provide the time information.

10. The aircraft of claim 7, wherein the flight control module is configured to fuse the flight control information into the image.

11. The aircraft of claim 7, further comprising: at least one of an angular sensor or a rotor motor, wherein the flight control information comprises operation status information of at least one of the angular sensor or the rotor motor.

12. The aircraft of claim 7, wherein the aircraft is configured to communicate with the somatosensory device, and wherein the flight control module is configured to transmit the flight control information and the image to the somatosensory device to enable the somatosensory device to process the flight control information to obtain somatosensory control information, and to control the somatosensory device based on the somatosensory control information.

13. A somatosensory system, comprising:
an aircraft comprising an imaging device and a flight control module;
a somatosensory device; and
a processor configured to:
control the imaging device to capture an image; and
associate and save the image and flight control information of the flight control module relating to a time when the imaging device captures the image.

14. The somatosensory system of claim 13, wherein the processor is configured to:
associate and save the image and time information relating to the time when the imaging device captures the image; and
associate and save the time information and the flight control information.

15. The somatosensory system of claim 13, wherein the aircraft comprises a timing device configured to provide the time information.

16. The somatosensory system of claim 13, wherein the processor is configured to fuse the flight control information into the image.

17. The somatosensory system of claim 13, wherein the aircraft comprises at least one of an angular sensor or a rotor motor, and wherein the flight control information comprises operation status information of at least one of the angular sensor or the rotor motor.

18. The somatosensory system of claim 17, wherein the aircraft comprises a gimbal, wherein the angular sensor is configured to detect attitude information of the gimbal, and wherein the operation status information of the angular sensor comprises a pitch angle, a yaw angle, and a roll angle of the gimbal.

19. The somatosensory system of claim 18, wherein the processor is configured to process the flight control information to obtain somatosensory control information, and to control the somatosensory device based on the somatosensory control information.

20. The somatosensory system of claim 19,
wherein the operation status information of the rotor motor is used to determine attitude information of the aircraft,
wherein the somatosensory device comprises a head somatosensory device and a body somatosensory device,
wherein the somatosensory control information comprises head control information for controlling the head somatosensory device and body control information for controlling the body somatosensory device,
wherein the processor is configured to determine the head control information and the body control information based on the attitude information of the gimbal and the attitude information of the aircraft.
